(19) United States
(12) Patent Application Publication
(10) Pub. No.: US 2020/0350533 A1
(43) Pub. Date: Nov. 5, 2020

(54) BATTERY HOUSING FOR A BATTERY SYSTEM FOR DRIVING A VEHICLE

(71) Applicant: Mahle International GmbH, Stuttgart (DE)

(72) Inventor: Johannes Weinmann, Stuttgart (DE)

(21) Appl. No.: 16/865,351

(22) Filed: May 2, 2020

(30) Foreign Application Priority Data
May 3, 2019 (DE) 10 2019 206 419.1
Aug. 1, 2019 (DE) 10 2019 211 560.8

(51) Int. Cl. H01M 2/10; B60K 1/04

(52) U.S. Cl. CPC H01M 2/1077; H01M 2220/20; B60K 1/04; H01M 2/1094

(57) ABSTRACT

A battery housing for a vehicle battery includes a housing cover and a housing tray. The housing cover and the housing tray while using a seal are connected to one another in a fluid-tight manner, wherein the housing cover has an extent in the longitudinal direction and in the transverse direction. The housing cover moreover includes reinforcement ribs. The reinforcement ribs are formed from three dissimilar rib types, wherein the three rib types are formed by longitudinal ribs, transverse ribs, and diagonal ribs. At least one nodal point is arranged on the housing cover, three reinforcement ribs which are formed by at least two dissimilar rib types intersecting one another in said nodal point.

### CROSS REFERENCE TO RELATED APPLICATIONS

This application claims priority to German patent application DE 10 2019 206 419.1, filed May 3, 2013, and DE 10 2019 211 560.8, filed Aug. 1, 2019, and the entire content of these applications is incorporated herein by reference.

### TECHNICAL FIELD

The disclosure relates to a battery housing for a battery system as well as to a battery system having such a battery housing.

### BACKGROUND

Battery housings for battery systems for driving vehicles are known. Accumulator cells which can receive and discharge electric energy are arranged in the battery housings. In addition to the accumulator cells, the electrical contacts are usually also arranged within the battery housing. The accumulator cells and the contact thereof are usually embodied as cell modules, wherein a plurality of cell modules are inserted into one battery housing. The battery housing has the task of protecting the cell modules against mechanical damage. Furthermore, the accumulator cells have to be temperature controlled in order to avoid overheating or undercooling, respectively, which would have a negative effect on the service life of the accumulator cells. It is known for a coolant, usually air, to be used for temperature-controlling the accumulator cells. The flow of air directly surrounds the accumulator cells and, depending on the operating state, thus introduces heat or dissipates heat. However, air-cooled batteries have a limited heat transfer which is why air-cooling is not sufficient in batteries with a high output. Cooling liquids are also known for achieving improved heat transfer. However, there is the problem that the liquid-conducting components herein must be tight. The sealing of large planar components thus represents a great challenge, in particular in the case of pressure pulses on account of a coolant pump.

### SUMMARY

It is an object of the present disclosure to provide an improved battery housing which can have a flow of a coolant passing therethrough and which in particular has an improved sealing.

This object is achieved by a battery housing and a battery system for driving a vehicle as described herein.

A battery housing according to an aspect of the disclosure is provided for a vehicle battery, thus for a battery system, which serves for driving the vehicle. Since a battery with a high output is required for driving a vehicle, reliable cooling of the accumulator cells arranged in the battery has to take place. This is achieved by direct cooling of the accumulator cells with a dielectric cooling liquid, thus a liquid coolant, in particular an oil. The cooling liquid herein streams directly about the accumulator cells. The cooling liquid is thus situated in the entire battery housing. The battery housing which encloses the accumulator cells, electrical contacts, and control units and contains the cooling liquid has a housing cover and a housing tray. The housing cover, while using a seal, is connected to the housing tray in a liquid-tight manner. The housing tray and the housing cover are typically formed from a thermoplastic plastics material. Alternatively, however, the housing tray and/or the housing cover may also be formed from a thermosetting plastics material or a metal. Both parts herein can be formed from the same material or be produced from dissimilar materials.

The housing cover has an extent in a longitudinal direction and in a transverse direction running orthogonally to the longitudinal direction. The housing cover on the surface thereof has reinforcement ribs. Said reinforcement ribs can be arranged on an internal side and/or on an external side of the housing cover. The reinforcement ribs are formed by three dissimilar rib types, wherein the different rib types are established by way of the profile thereof on the surface of the housing cover. Reinforcement ribs running in the longitudinal direction will be referred to hereunder as longitudinal ribs. Reinforcement ribs running in the transverse direction will be referred to hereunder as transverse ribs, and reinforcement ribs which run at an angle unequal to 90° to both the longitudinal direction as well as the transverse direction will be referred to hereunder as diagonal ribs. The diagonal ribs typically run at an angle between approx. 30° to 60° to the longitudinal direction or the transverse direction on the external-side, or internal-side, respectively, surface of the housing cover. The diagonal ribs typically run at an angle of 45° to the longitudinal direction and the transverse direction. The spacings between neighbouring reinforcement ribs of one specific rib type may be equal or decrease towards the centre of the component, on account of which an additional reinforcement of the housing cover is achieved. The rib widths of the reinforcement ribs of all rib types can be identical. However, it is also possible for a specific rib type to have a wider or narrower rib width than the two other rib types.

It is understood that at least one reinforcement trip, typically two or a plurality of reinforcement ribs, irrespective of which rib type said reinforcement rib/ribs is/are assigned to, can intersect two or more nodal points as explained above, or terminate in two or more nodal points.

In order for the stiffness of the component of the housing cover to be increased, at least one nodal point is present on the housing cover, three reinforcement ribs which are assigned to three dissimilar rib types intersecting in said nodal point. A plurality of such nodal points is typically provided. In this case, at least one reinforcement rib, irrespective of which rib type said reinforcement rib is assigned to, intersects two reinforcement ribs of a respective other rib type in two or more nodal points. In this way, the forces absorbed in the reinforcement ribs are divided and dissipated in a particularly effective manner to the adjacent reinforcement ribs of the other rib type(s).

According to one exemplary embodiment, at least one diagonal rib intersects at least one longitudinal or one transverse rib in the at least one nodal point. A particularly enhanced reinforcement of the housing cover is associated with such a disposal of the reinforcement ribs.

At least a first and at least a second diagonal rib which are mutually displaced at a typically acute angle can particularly typically be provided. A particularly strong reinforcement of the housing cover is also associated with such a disposal of the reinforcement ribs.

According to an exemplary embodiment, two diagonal ribs intersect one another in the at least one nodal point. A particularly enhanced reinforcement of the housing cover is also associated with such a disposal of the reinforcement ribs.

According to an exemplary embodiment, at least three reinforcement ribs which are assigned to three different rib types intersect in each case in a plurality of nodal points. A particularly enhanced reinforcement of the housing cover is also associated with such a disposal of the reinforcement ribs.

It is advantageous for the nodal point, when viewed in a direction perpendicular onto the housing cover, to have a substantially circular external circumference. The introduced forces can thus be uniformly dissipated to the adjacent reinforcement ribs. The nodal point can additionally has a circular recess on account of which an accumulation of material is prevented. This is particularly advantageous in the case of an exemplary embodiment of the housing cover as a plastics-material part so as to reduce accumulations of material which would lead to a heavier incursion.

In one further exemplary embodiment the housing cover in the longitudinal direction has two outer peripheral zones and one central zone arranged between the peripheral zones. The housing cover in the transverse direction likewise has two peripheral regions and one central region arranged between the peripheral regions. Nine dissimilar areas which are formed by the regions where the peripheral and central zones overlap with the peripheral and central regions thus result on the housing cover. Each of said areas can have an individual reinforcement rib pattern. No reinforcement ribs are typically arranged in those areas where peripheral zones intersect peripheral regions. Only a single rib type, in particular longitudinal ribs or transverse ribs, is arranged in those areas where the peripheral zones, or the peripheral regions, respectively, intersect the central region, or the central zone, respectively. The diagonal ribs are typically arranged in that area where the central zone and the central region intersect. In addition to the diagonal ribs, one further rib type, or even both rib types, thus longitudinal ribs and diagonal ribs, can be arranged in this area. The region of the battery housing which is particularly critical in terms of pressure stability is thus stabilized in an optimal manner.

According to one exemplary embodiment, a plurality of transverse ribs is arranged in the overlap region, said plurality of transverse ribs in a plurality of nodal points intersecting a plurality of diagonal ribs which are likewise arranged in the overlap region. A particularly enhanced reinforcement of the housing cover is associated with such a disposal of the reinforcement ribs.

According to one other exemplary embodiment, at least three reinforcement ribs which are assigned to dissimilar rib types intersect in at least one central nodal point, typically in at least two nodal points. A particularly enhanced reinforcement of the housing cover is also associated with such a disposal of the reinforcement ribs.

According to one exemplary embodiment, one or a plurality of the transverse ribs in the region of the central zone can have a clearance, wherein the clearance/clearances lie in the peripheral region. Add-on parts such as, for example, supply lines, can be arranged in said clearance. Alternatively or additionally to this exemplary embodiment, the longitudinal rib in the peripheral zones can likewise have a clearance of this type.

It is advantageous for the housing cover to be configured so as to be convex, since an improved distribution of pressure is achieved in the interior of the battery housing on account thereof. The housing cover herein can be configured so as to be convex in the longitudinal direction and/or in the transverse direction. The resulting curvature is also referred to as a cambered shape.

According to an exemplary embodiment, the reinforcement ribs can have dissimilar heights. The reinforcement ribs of one rib type herein can have the same height, and the height differential can exist between the rib types. However, it is also possible for dissimilar heights to be configured within one rib type. Dissimilar heights which can be adapted to the requirements of the installation space and/or the pressure can be implemented in particular in the profile of one reinforcement rib.

According to another exemplary embodiment of the battery housing, the housing cover is configured to have no longitudinal ribs in its central zone, such that said central zone is free of longitudinal ribs. This advantageously goes hand in hand with a reduction of material being used to form the reinforcement ribs.

Typically, the reinforcement ribs are solely formed in an external or an internal side of the housing cover, wherein the external circumference of the housing cover is free of reinforcement ribs. This results in a further reduction of material needed as to for the reinforcement ribs.

According to another exemplary embodiment, a rib pattern in which the reinforcement ribs are arranged is not axisymmetric to the longitudinal direction. This helps identifying an orientation of the cover opposite the housing tray, such that an assembly of the battery housing is simplified.

Further important features and advantages of the disclosure are derived from the dependent claims, from the drawings, and from the associated description of the figures.

It is understood that the features mentioned above and yet to be explained hereunder can be used not only in the respective stated combination but also in other combinations or individually without departing from the scope of the present disclosure.

Exemplary embodiments of the disclosure are illustrated in the drawings and will be explained in more detail in the description hereunder, wherein identical reference signs refer to identical or similar or functionally equivalent components.

### BRIEF DESCRIPTION OF THE DRAWINGS

The disclosure will now be described with reference to the drawings wherein:

FIG. 1 shows a battery housing in a plan view;

FIG. 2 shows the battery housing in a section along the section line X-X of FIG. 1;

FIG. 3 shows an isometric view of the housing cover in one variant; and

FIG. 4 shows an isometric view of the housing cover in a further variant.

### DESCRIPTION OF EXEMPLARY EMBODIMENTS

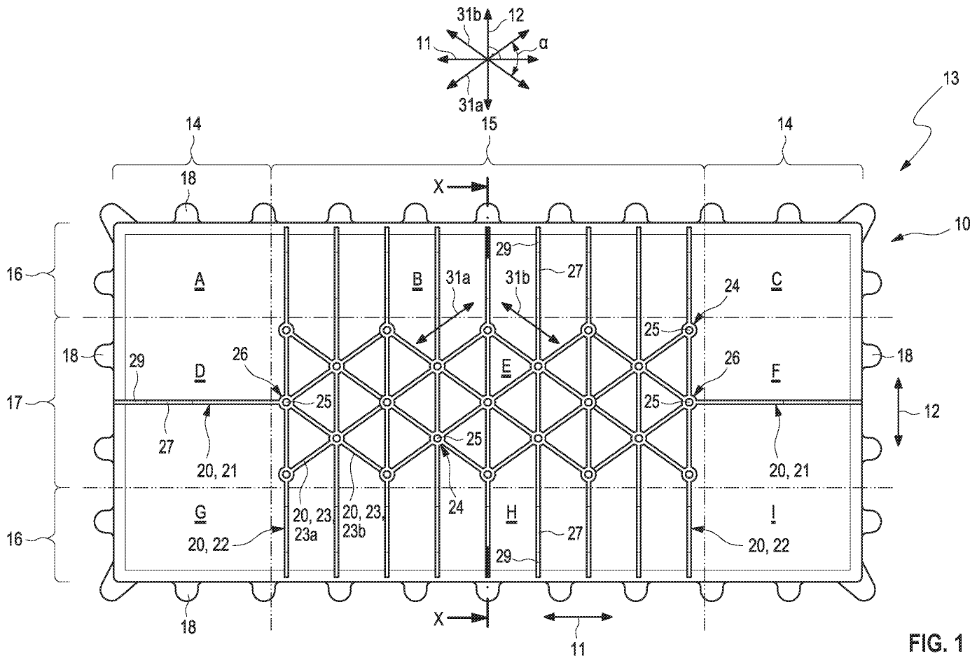

A battery housing 13 is illustrated in a plan view in FIG. 1. Therefore, only a housing cover 10 of the battery housing 13 can be seen. The housing cover 10 has an extent in a longitudinal direction 11 and in a transverse direction 12 which runs orthogonally to the longitudinal direction 11. The housing cover 10 in the longitudinal direction 11 herein is subdivided into two peripheral zones 14 and one central zone 15. The central zone 15 is arranged between the peripheral zones 14. The housing cover 10 in the transverse direction 12 is likewise subdivided, specifically into two peripheral region 16 and one central region 17. Nine areas which will be referred to hereunder by A, B, C, D, E, F, G, H, and I result from the subdivision. Fastening eyelets 18 which are provided for connecting the housing cover 10 to a housing tray 19 are arranged so as to be distributed in an encircling manner on the external circumference of the housing cover 10.

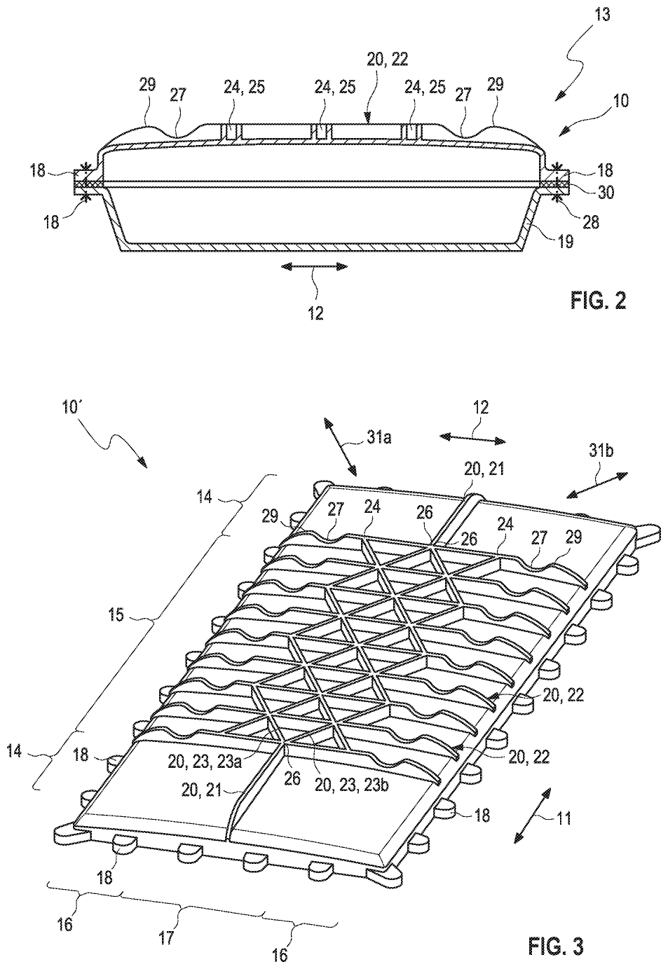

This is highlighted by the illustration of FIG. 2 which shows the battery housing 13 of FIG. 1 in a section along the section line X-X of FIG. 1.

The fastening eyelets 18 can be used for bracing. Alternatively however, bores (not illustrated) can be incorporated in the fastening eyelets 18 so as to enable screw-fitting through the fastening eyelets 18.

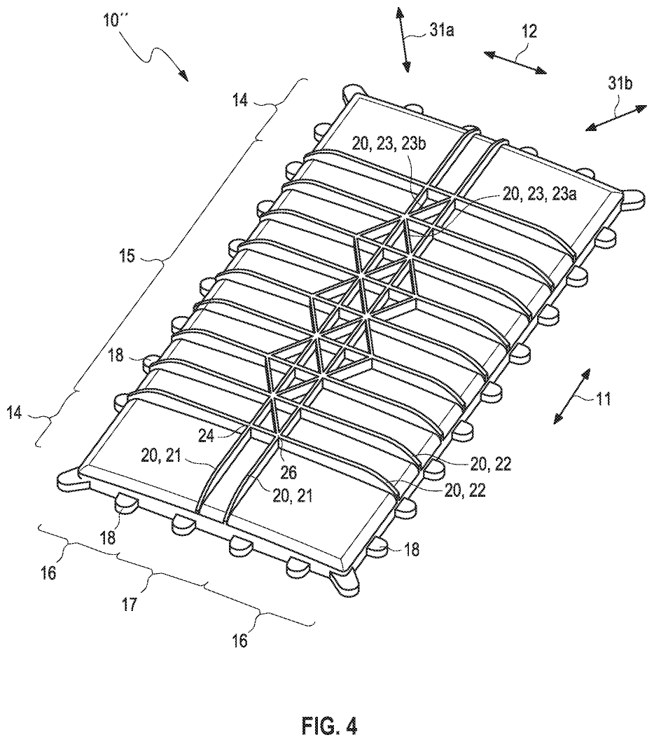

The housing cover 10 according to FIG. 1 on the external-side surface thereof has reinforcement ribs 20. Said reinforcement ribs 20 are divided into three rib types, this being established according to the directional profile of the reinforcement rib 20. Longitudinal ribs 21 run in the longitudinal direction 11. A longitudinal rib 21, which is arranged so as to be centric and is interrupted in the area E and thus runs only in the areas D and F, is provided in the present exemplary embodiment. However, in other exemplary embodiments the longitudinal rib 21 can also be arranged so as to be continuous. This is illustrated in exemplary manner in FIG. 4.

Transverse ribs 22 run in the transverse direction 12. Diagonal ribs 23 run obliquely to the longitudinal direction 11 and also obliquely to the transverse direction 12. The reinforcement ribs 20 of the dissimilar rib types, or of the diagonal ribs 23, respectively, meet in nodal points 24. The nodal points 24 are characterized in that at least one diagonal rib 23 intersects a longitudinal or a transverse rib 21, 22 in said nodal points 24.

As shown in FIG. 1, the diagonal ribs 23 can be subdivided into first and second diagonal ribs 23a, 23b. The first diagonal ribs 23a all extend along a first diagonal direction 31a; the second diagonal ribs extend along a second diagonal direction 31b which differs from the first diagonal direction 31a. The first and the second diagonal direction 31a, 31b are mutually arranged at an intermediate angle α which, as is shown in FIG. 1, can typically be an acute angle. The intermediate angle α is particularly typically 90°. The first as well as the second diagonal direction 31a, 31b run obliquely, thus at an angle, typically at an angle of 45°, to the longitudinal direction 11 as well as to the transverse direction 12. A first and a second diagonal rib 23a, 23b intersect in the nodal points 24, or said first and said second diagonal rib 23a, 23b terminate in the nodal points 24.

The nodal points 24 can have a circular external circumference for the advantageous distribution of force. The nodal points 24 typically have cylindrical recesses 25 for avoiding accumulations of material. Said recesses 25 in particular design embodiments can be used as fastening points, for example as screw-fitting points, for add-on components (not illustrated). The areas A, C, G, and I have a typically planar surface without reinforcement ribs 20. Only transverse ribs 22 are arranged in the areas B and H. Only longitudinal ribs 21 are arranged in the areas D and F. The transverse ribs 22 as well as diagonal ribs 23 are arranged in the area E. All three rib types 21, 22, 23 meet in two central nodal points 26 in which the introduction or dissipation, respectively, of the forces from the reinforcement ribs 20 takes place.

The transverse ribs 22 as well as the longitudinal ribs 21 have an arcuate clearance 27 which can be clearly seen in FIG. 2. The flux of force is disturbed to only a minimal extent on account of the arcuate clearance 27. Additional components such as, for example, lines (not illustrated) can be arranged in a space-saving manner within the clearance 27. In exemplary embodiments the clearances 27 could form a snap-fit connection for the lines.

A plurality of transverse ribs 22 are arranged in the area E, presently also referred to as the “overlap region”, said plurality of transverse ribs 22 in a plurality of nodal points 24 intersecting a plurality of diagonal ribs 23 which are likewise arranged in the overlap region E. The diagonal ribs 23 of the area E herein are formed by first as well as by second diagonal ribs 23a, 23b.

The battery housing 13 in FIG. 2 is illustrated in the section along the section line X-X of FIG. 1. Identical components are provided with identical reference signs. The housing cover 10 is screw-fitted to the housing tray 19, wherein the screws 28 are only schematically indicated. An encircling seal 30 is arranged between the housing cover 10 and the housing tray 19. The components which are usually arranged in a battery housing, as well as inflows and outflows for the coolant, or the electrical contacts, are not illustrated. The housing cover 10 in this exemplary embodiment is embodied so as to be outwardly convex. The pressure of the liquid acting from the inside on the housing cover 10 is thus distributed along the arcuate shape. This internal pressure is dissipated by the reinforcement ribs 20 arranged on the external face, on account of which the battery housing 13 is embodied so as to be pressure-resistant in terms of the internal pressure. The transverse rib 22 at both ends has a hump 29 which reduces or entirely prevents bulging at the periphery. The longitudinal rib 21 at the ends thereof, in a manner analogous to the transverse rib 22, also has such a hump 29, and between the hump 29 and the central nodal point 26 has the clearance 27.

A housing cover 10′ in a slightly modified exemplary embodiment is illustrated in FIG. 3. Identical components are provided with identical reference signs. As opposed to the housing cover 10 illustrated in FIG. 1, the longitudinal rib 21 is configured without a clearance 27 and without a hump 29. Like the transverse ribs 22 according to FIGS. 1 and 2, the profile of the longitudinal rib 21 also ends in an arc so as to avoid stress concentrations. A further point of differentiation in relation to the housing cover 10 illustrated in FIG. 1 lies in that the nodal points 24 are embodied without a recess 25.

As shown in FIGS. 1 and 3, the central zone 15 is free of longitudinal ribs 21. It is also shown that reinforcement ribs 20 are solely formed on an external side of the housing cover 10, wherein the external circumference is free of reinforcement ribs 20.

A further alternative exemplary embodiment of the housing cover 10″ is shown in FIG. 4. Identical components are provided with identical reference signs. As opposed to the housing cover 10 illustrated in FIG. 3, neither the longitudinal ribs 21 nor the transverse ribs 22 has clearances 27 or humps 29. The reinforcement ribs 20 run in a substantially rectilinear manner. Furthermore, provided are two parallel continuous longitudinal ribs 21 which intersect the transverse ribs 22. The diagonal ribs 23 intersect the longitudinal ribs as well as the transverse ribs 21, 22, on account of which the forces are transmitted to the longitudinal ribs and transverse ribs 21, 22.

It is understood that the foregoing description is that of the exemplary embodiments of the disclosure and that various changes and modifications may be made thereto without departing from the spirit and scope of the disclosure as defined in the appended claims.

What is claimed is:

1. A battery housing for a vehicle battery, the battery housing comprising:
a housing cover; and
a housing tray,
wherein the housing cover and the housing tray are connected to one another with a seal in a fluid-tight manner;
wherein the housing cover includes an extent in the longitudinal direction and in the transverse direction;
wherein the housing cover includes reinforcement ribs,
wherein the reinforcement ribs are formed from three dissimilar rib types,
wherein the three rib types are formed by longitudinal ribs, transverse ribs, and diagonal ribs;
wherein at least one nodal point is arranged on the housing cover, and
wherein three reinforcement ribs are formed by at least two, typically precisely two or precisely three, dissimilar rib types intersecting one another in said nodal point.

2. The battery housing according to claim 1, wherein at least one diagonal rib intersects a longitudinal or a diagonal rib in the at least one nodal point.

3. The battery housing according to claim 1, further comprising:
at least a first diagonal rib and a second diagonal rib which are mutually arranged at a typically acute angle.

4. The battery housing according to claim 1, wherein a first diagonal rib and a second diagonal rib intersect one another in the at least one nodal point.

5. The battery housing according to claim 1, wherein the at least one nodal point, when viewed in a direction perpendicular onto the housing cover, has a substantially circular external circumference, and
wherein the nodal point additionally has a circular recess.

6. The battery housing according to claim 1, wherein the housing cover in the longitudinal direction includes two peripheral zones and one central zone, and in the transverse direction includes two peripheral regions and one central region, and
wherein only longitudinal ribs are provided in the peripheral zones and/or only transverse ribs are provided in the peripheral region.

7. The battery housing according to claim 6, wherein the central region and the central zone form an overlap region in which all diagonal ribs are arranged.

8. The battery housing according to claim 7, wherein a plurality of transverse ribs is arranged in the overlap region, said plurality of transverse ribs in a plurality of nodal points intersecting a plurality of diagonal ribs which are likewise arranged in the overlap region.

9. The battery housing according to claim 1, wherein at least three reinforcement ribs which are assigned to dissimilar rib types intersect in at least one central nodal point or in at least two nodal points.

10. The battery housing according to claim 6, wherein the transverse ribs in the region of the central zone has clearances, and
wherein the clearances are arranged in the peripheral region.

11. The battery housing according to claim 3, wherein at least one longitudinal rib in the central zone has a clearance, and
wherein the clearance is arranged in the peripheral zone.

12. The battery housing according to claim 1, wherein the housing cover in the longitudinal direction and/or in the transverse direction is configured to be convex.

13. The battery housing according to claim 1, wherein at least two reinforcement ribs have dissimilar heights.

14. The battery housing according to claim 1, wherein the central zone is free of longitudinal ribs.

15. The battery housing according to claim 1, wherein reinforcement ribs are solely formed on an external or an internal side of the housing cover, and
wherein the external circumference is free of reinforcement ribs.

16. The battery housing according to claim 1, wherein a rib pattern in which the reinforcement ribs are arranged is not axisymmetric to the longitudinal direction.

17. A battery system for driving a vehicle, in particular an electric vehicle, the battery system comprising:
a battery housing according to claim 1, and
a plurality of accumulator cells arranged in the battery housing.
